(19) United States
(12) Patent Application Publication
(10) Pub. No.: US 2025/0390384 A1
(43) Pub. Date: Dec. 25, 2025

(54) EXCEPTION HANDLER BASED ERROR CORRECTION FOR PROCESSORS

(71) Applicant: Altera Corporation, San Jose, CA (US)

(72) Inventor: Richard HERVEILLE, El Dorado Hills, CA (US)

(21) Appl. No.: 19/315,435

(22) Filed: Aug. 29, 2025

(51) Int. Cl. G06F 11/10

(52) U.S. Cl. CPC G06F 11/1044

(57) ABSTRACT

An apparatus of an aspect includes a storage having a plurality of storage locations, including a storage location to store data, an execution unit to execute an instruction to access the data, and an error correction code (ECC) decoder. The ECC decoder, when the data is erroneous data having one or more correctable errors, is to detect the one or more correctable errors in the erroneous data and correct the one or more correctable errors. The apparatus also includes circuitry to store information to indicate the storage location in an error log and circuitry to transition to an exception handler corresponding to an exception due to the one or more correctable errors. Other apparatus, methods, and systems are disclosed.

### BACKGROUND

### Technical Field

Embodiments described herein generally relate to data storage. In particular, embodiments described herein generally relate to correcting errors in stored data.

### Background Information

Errors may occasionally be introduced into data stored in registers, caches, shared memory, tightly coupled memory, external system memory, and other types of storage. For example, a transient bit flip may occur in which the value of a bit may change from a first value (e.g., binary one) to a second value (e.g., binary zero). Such errors may occur for various reasons, such as, for example, a cosmic particle impacting the storage, timing imperfections, device aging, imperfect hardware, or a combination thereof. If undetected, such errors may lead to silent data corruption, erroneous computations, incorrect program behavior, and loss of data.

Commonly, error correction code (ECC) bits may be included for the data in the storage to help detect and correct such errors. The ECC bits may be extra bits computed based on original data bits using an ECC algorithm or scheme (e.g., Hamming codes, Reed-Solomon codes, BCH codes, etc.). These ECC bits along with the original data bits may have a level of redundancy that can be used to a certain extent to detect and correct such errors as long as the original data bits do not have too many errors. Generally, the more ECC bits the greater the error detection and correction capabilities. As one example, a lesser given number of ECC bits may be sufficient to detect and correct single-bit errors and to detect but not correct double-bit errors, whereas a greater given number of ECC bits may be sufficient to detect and correct single-bit or double-bit errors and to detect but not correct triple-bit errors.

### BRIEF DESCRIPTION OF THE DRAWINGS

Various examples in accordance with the present disclosure will be described with reference to the drawings, in which:

FIG. 1 is a block diagram illustrating operation of a processor, having an ECC encoder, a storage 04, an ECC decoder, and an exception handler, according to some embodiments.

FIG. 2 is a block diagram of an embodiment of a computer system in which embodiments of the invention may be implemented.

FIG. 3 is a block flow diagram of an embodiment of a method of correcting ECC errors in data with an exception handler.

FIG. 4 is a block diagram of a first embodiment of an exception handler having a read-not modify-write instruction and a processor to perform the read-not modify-write instruction.

FIG. 5 is a block diagram of a second embodiment of an exception handler having a load instruction and a write instruction and processor to perform the load instruction and the write instruction.

FIG. 6 illustrates an example computing system.

FIG. 7 illustrates a block diagram of an example processor and/or System on a Chip (SoC) that may have one or more cores and an integrated memory controller.

FIG. 8(A) is a block diagram illustrating both an example in-order pipeline and an example register renaming, out-of-order issue/execution pipeline according to examples.

FIG. 8(B) is a block diagram illustrating both an example in-order architecture core and an example register renaming, out-of-order issue/execution architecture core to be included in a processor according to examples.

FIG. 9 illustrates examples of execution unit(s) circuitry.

FIG. 10 is a block diagram of a register architecture according to some examples.

FIG. 11 illustrates examples of an instruction format.

FIG. 12 illustrates examples of an addressing information field.

FIG. 13 illustrates examples of a first prefix.

FIGS. 14(A)-(D) illustrate examples of how the R, X, and B fields of the first prefix in FIG. 13 are used.

FIGS. 15(A)-(B) illustrate examples of a second prefix.

FIG. 16 illustrates examples of a third prefix.

FIG. 17 is a block diagram illustrating the use of a software instruction converter to convert binary instructions in a source instruction set architecture to binary instructions in a target instruction set architecture according to examples.

### DETAILED DESCRIPTION OF EMBODIMENTS

The present disclosure relates to apparatus, methods, and systems to correct errors in data stored in storage. In the following description, numerous specific details are set forth (e.g., specific configurations of components, microarchitectural details, sequences of operations, etc.). However, embodiments may be practiced without these specific details. In other instances, well-known circuits, structures, and techniques have not been shown in detail to avoid obscuring the understanding of the description.

As mentioned in the background section, errors may occasionally be introduced into data stored in registers, caches, shared memory, tightly coupled memory, external system memory, and other types of storage. ECC bits may be included for the data to help detect and correct such errors. However, even when such errors can be detected and corrected in the data output from the storage by using the ECC bits, additional errors in the data in the storage may occur over time, leading to an accumulation of the errors. At some point, there may be too many errors in the data for the ECC bits to be able to correct or even detect the errors. In some embodiments, to help prevent or at least reduce the accumulation of such errors, data which has been read out of the storage and corrected of one or more such errors by using the ECC bits may be written back to the storage thereby overwriting the data having the one or more errors (e.g., the erroneous data) in the storage, which may effectively correct or fix the one or more errors in the data stored in the storage.

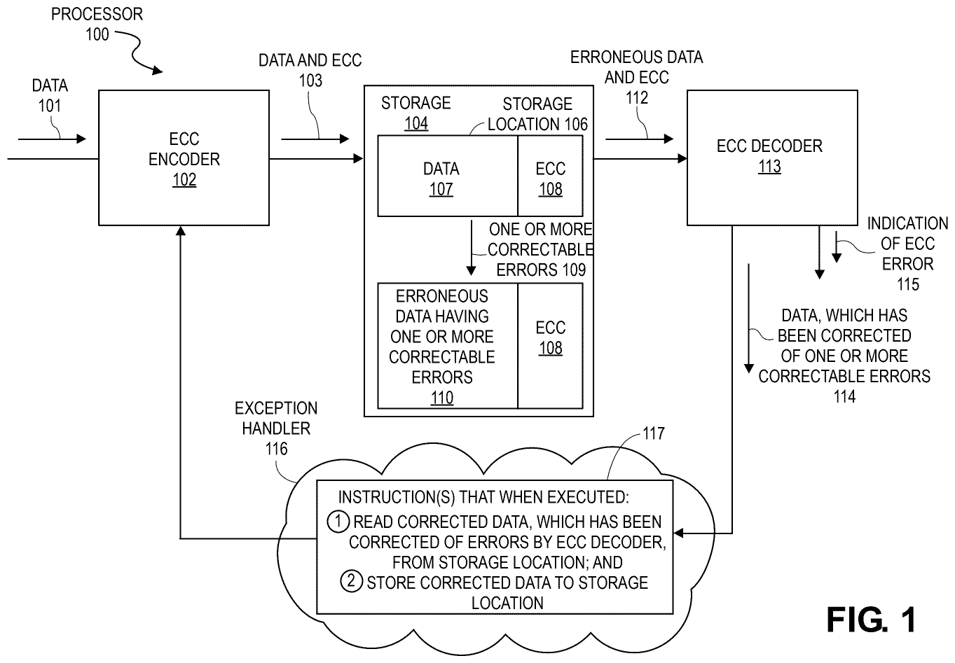

FIG. 1 is a block diagram illustrating operation of a processor 100, having an ECC encoder 102, a storage 104, an ECC decoder 113, and an exception handler 116, according to some embodiments. By way of example, the storage may be a set of registers (e.g., general-purpose registers, floating-point registers, vector registers, or other registers), a cache (e.g., a Level 1 (L1) instruction cache, a L1 data cache, a unified Level 2 (L2) cache, a Level 3 (L3 cache), a shared cache, etc.), a shared memory, a tightly coupled memory, or other type of storage. The storage 104 has a number of storage locations (e.g., general-purpose, floating-point, or vector registers, cache line storage locations, etc.), including a storage location 106.

Initially, data 101 may be stored to the storage location 104. By way of example, the data may be an integer value to be stored in a general-purpose register, a floating-point value to be stored in a floating-point register, a cache line to be stored in a cache line storage location, etc. The ECC encoder 102 may generate one or more ECC bits 108 for the data and output the data and ECC bits 103. Then, the data 107 may be stored in the storage location 106. The ECC bits 108 may also be stored for the data. The ECC bits correspond to the data and/or are to be used to attempt to detect and correct errors in the data. In the illustrated example, the ECC bits are stored in an extension of the storage location. Alternatively, the ECC bits may be stored elsewhere (e.g., in a separate ECC storage generally included alongside or proximate to the storage 104).

At some point, one or more correctable errors 109 may be introduced into the data 107 (e.g., due to cosmic radiation or one of the other reasons mentioned above) thereby turning the data 107 into erroneous data 110 having the one or more correctable errors. The same ECC bits 108 still correspond to and/or are to be used for this erroneous data 110.

When the erroneous data 110 is accessed, the erroneous data and the ECC may be output to the ECC decoder 113. The ECC decoder may operate on the erroneous data and the one or more ECC bits according to an ECC algorithm or scheme (e.g., based on Hamming codes, Reed-Solomon codes, BCH codes, etc.) and may detect the one or more correctable errors in the erroneous data and correct the one or more correctable errors. The ECC decoder may output corrected data 114 (e.g., equal to the data 107), which has been corrected of the one or more correctable errors. In some embodiments, the ECC decoder may also optionally output an indication of an ECC error 115 (e.g., that one or more errors were detected in the data).

In some embodiments, the exception handler 116 may include one or more instructions that when executed: (1) read corrected data 114, which has been corrected of one or more correctable errors present in the erroneous data 110 by the ECC decoder 113 using the ECC bits 108; and (2) store the corrected data back to the storage location 106 overwriting the erroneous data 110 thereby effectively correcting or fixing the one or more correctable errors and turning the erroneous data 110 back into the data 107. Advantageously, this may help to prevent or at least reduce the accumulation of such errors which could otherwise result in too many errors for the ECC bits to be able to correct or even detect them.

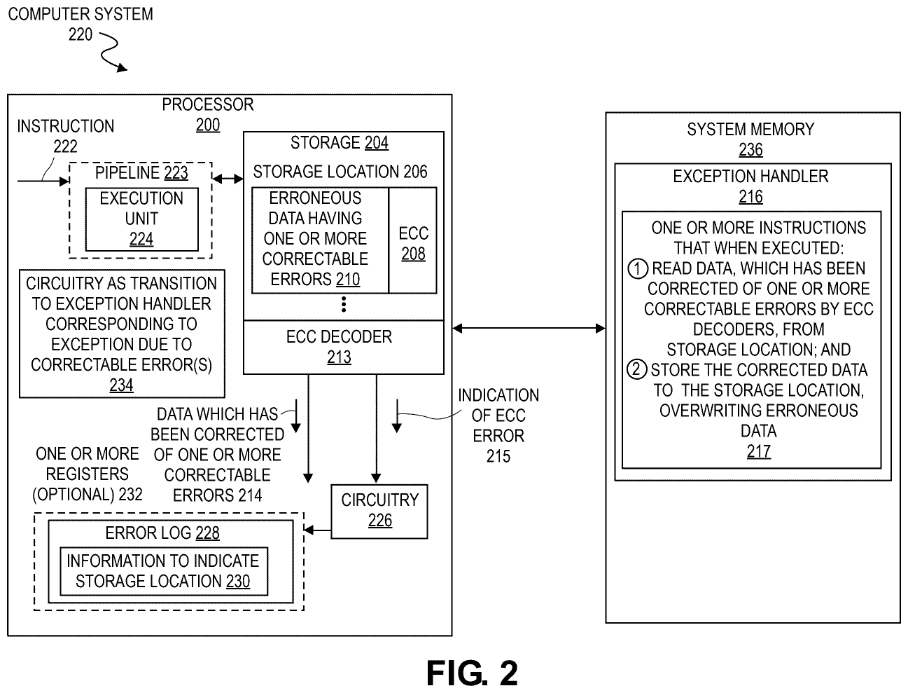

FIG. 2 is a block diagram of an embodiment of a computer system 220 in which embodiments of the invention may be implemented. In various embodiments, the computer system may represent a desktop computer, a laptop computer, a smartphone, a server, a network device (e.g., a router, switch, etc.), or other type of computer system. The computer system includes a processor 200 coupled with a system memory 236 (e.g., by one or more interconnects, chipset components, etc.).

In various embodiments, the processor may be a general-purpose microprocessor or central processing unit (CPU), a graphics processing unit (GPU), a digital signal processors (DSPs), a field-programmable gate array (FPGA), an application specific integrated circuits (ASIC), an artificial intelligence processor, a machine learning processor, a microcontroller, or other type of processor known in the arts. In some embodiments, the processor may include (e.g., be disposed on) at least one integrated circuit and/or semiconductor die. In some embodiments, the processor may include at least some hardware (e.g., transistors, circuitry, random access memory (RAM), etc.).

The processor includes a storage 204. By way of example, the storage may be a set of registers (e.g., general-purpose, floating-point, vector, or other registers), a cache (e.g., an L1 instruction cache, a L1 data cache, a unified L2 cache, an L3 cache, or a shared cache), a shared memory, a tightly coupled memory, or other type of storage. Also, the approaches described herein may be used for data stored in the system memory, as will be discussed elsewhere herein. The storage 204 has a number of storage locations (e.g., general-purpose, floating-point, or vector registers, cache line storage locations, shared memory locations, tightly coupled memory locations, etc.), including a storage location 206.

Erroneous data 210 having one or more correctable errors is stored in the storage location 206. By way of example, the erroneous data may represent an integer value, floating-point value, vector, or cacheline into which the one or more correctable errors have been introduced. ECC bits 208 may also be stored for the data. The ECC bits correspond to the erroneous data and/or are to be used to detect and correct errors in the erroneous data. The one or more correctable errors are referred to as correctable because they are sufficiently few that they can be corrected by the ECC bits. In the illustrated example, the ECC bits are stored in an extension of the storage location. Alternatively, the ECC bits may be stored elsewhere (e.g., in a separate ECC storage generally included alongside or proximate the storage 204).

The processor also includes at least one execution unit 224 (e.g., part of a pipeline 223 of the processor) to execute an instruction 222 to access the erroneous data 210 in the storage location 206. When the erroneous data 210 is accessed, the erroneous data and the ECC may be provided to an ECC decoder 213. The ECC decoder 213, when the erroneous data 210 is accessed from the storage location 206, may detect and correct the one or more correctable errors in the erroneous data. By way of example, the ECC decoder may operate on the erroneous data and the one or more ECC bits according to an ECC algorithm or scheme (e.g., based on Hamming codes, Reed-Solomon codes, BCH codes, etc.). The ECC decoder may output corrected data 214, which has been corrected of the one or more correctable errors. In some embodiments, the ECC decoder may also optionally output a signal or other an indication of an ECC error 215 (e.g., that one or more errors were detected in the erroneous data). This indication may take different forms, such as, for example, asserting a signal high on a wire, changing the value of a bit in a register, etc.

The processor also includes circuitry 226 (e.g., exception handling circuitry) to store information associated with the ECC error in an error log 228. In some embodiments, the circuitry may store information 230 to indicate the storage location 206 storing the erroneous data 210 in the error log. As one example, the storage 204 may be a set of registers, the storage location 206 may be a given register of the set of registers, and the information 230 may be the register number of the given register which is the storage location 206. As another example, the storage 204 may be any one of a cache, a shared memory, a tightly coupled memory, and external system memory, and the information 230 may include memory address information to indicate a memory address corresponding to and/or addressing the storage location 206. In some embodiments, the circuitry may optionally store one or more other types of information associated with the ECC error in an error log 228. Examples of such information include, but are not limited to, information to indicate the storage 204, information to indicate that the one or more correctable errors in the erroneous data 210 are correctable (e.g., as opposed to being uncorrectable), information to indicate that the one or more correctable errors in the erroneous data 210 are one or more ECC errors, and the like, and any combination of such information. As shown, in some embodiments, the processor may optionally include one or more registers 232 (e.g., control and/or status registers, model specific registers, etc.) to store the error log 228. Alternatively, the error log 228 may optionally be stored in the system memory 236 or elsewhere.

The processor also includes circuitry 234 to transition to an exception handler 216 corresponding to and/or operative to handle an exception that occurs or will occur due to and/or based on the detection of the one or more correctable errors in the erroneous data. The exception handler includes one or more instructions 217. In some embodiments, these one or more instructions may be one or more macroinstructions or other instructions of an instruction set of the processor 200. In some embodiments, these one or more instructions 217, when executed by the processor (e.g., one or more execution units thereof), may be operative to cause the processor to perform operations, including to: (1) read corrected data 214, which has been corrected of one or more correctable errors present in the erroneous data 210 by the ECC decoder 213 using the ECC bits 208, from the storage location 206; and (2) write or store the same unmodified and/or unchanged corrected data back to the storage location 206 overwriting the erroneous data 210 presently stored therein and thereby effectively correcting or fixing the one or more correctable errors (e.g., overwriting a wrong bit value with a correct bit value). The exception handler may read an error log to determine the storage location and in some cases the storage having the storage location as well as other optional information in the error log. Advantageously, this may help to prevent or at least reduce the likelihood of accumulation of such errors over time, which could otherwise result in too many errors for the ECC bits to be able to correct or even detect them.

In some embodiments, the one or more instructions include an instruction to read correct data from an indicated storage location (e.g., thereby causing erroneous data to be corrected of one or more correctable errors by the ECC decoder converting it to the correct data), not change or modify the correct data that has been read, and then write the same unchanged or unmodified correct data back to the indicated storage location overwriting the erroneous data. This instruction may also be referred to herein as a read-not modify-write instruction. The read, not modify, write instruction may specify (e.g., have one or more fields or bits to explicitly specify) or otherwise indicate (e.g., implicitly indicate) a register as the storage location 206 (e.g., a general-purpose register, floating-point register, vector register, etc.) to be used as both a source register from which to read the data and as a destination register where the unchanged or unmodified data is to be written or stored. One example of a suitable read-not modify-write instruction is a register-to-register move instruction that specifies or otherwise indicates the same register for both its source register and its destination register. Another example of a suitable read-not modify-write instruction is a logical OR instruction that specifies or otherwise indicates the same register for a first source register, a second source register, and a destination register. Yet another example of a suitable read-not modify-write instruction is a multiply instruction that specifies or otherwise indicates a first source register having a value of one and a second different register for both a second source register and a destination register. The multiply instruction multiplies the data from the second source register by one thereby leaving its value unmodified or unchanged before writing the same unmodified or unchanged data back to the same second source register (e.g., also the destination register). Other examples of suitable read-not modify-write instructions can be based on adding zero, shifting by zero, taking the minimum or maximum of the same given register specified for first and second source registers and the destination register, etc.

In other embodiments, the one or more instructions include a load or read instruction that specifies or otherwise indicates a memory location and a store or write instruction that also specifies or otherwise indicates the memory location. The load or read instruction when executed may cause an execution unit and/or the processor to load or read corrected data from the memory location, which may be in a cache, shared memory, tightly coupled memory, or system memory, and store the corrected data to a destination (e.g., a register). The store or write instruction when executed may cause an execution unit and/or the processor to store or write the unchanged/unmodified corrected data (e.g., from the same register) to the memory location, which may be in the same cache, shared memory, tightly coupled memory, or system memory, to overwrite the erroneous data.

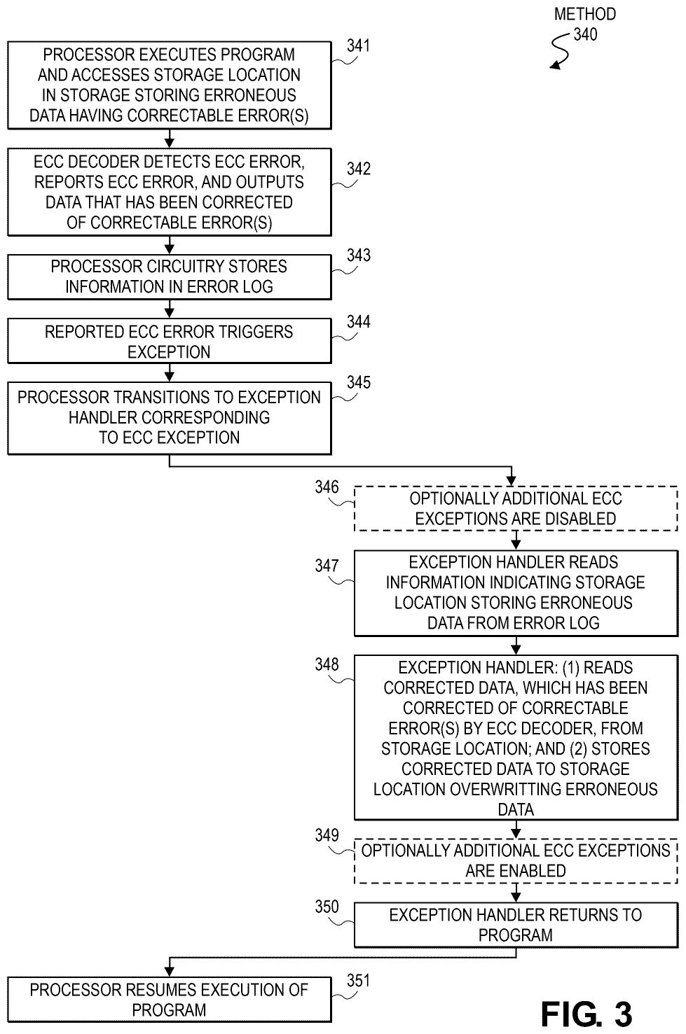

FIG. 3 is a block flow diagram of an embodiment of a method 340 of correcting ECC errors in data with an exception handler. In some embodiments, the method 340 may be performed by and/or with the computer system 220 of FIG. 2. The components, features, and specific optional details described herein for the computer system 220 also optionally apply to the method 340. Alternatively, the method 340 may be performed by and/or within a similar or different computer system or other electronic device. Moreover, the computer system 220 may perform methods the same as, similar to, or different than the method 340.

The method includes a number of options. Operations that may be performed by a processor, a system-on-chip (SoC), or hardware are shown on the left-hand side, whereas operations that may be performed by an exception handler (e.g., software and/or firmware) are shown on the right-hand side. Another embodiment of a method may include operations like those on the left-hand side alone without those on the right-hand side. Yet another embodiment of a method may include operations like those on the right-hand side alone without those on the left-hand side.

At block 341, a processor executes a program and accesses a storage location in a storage where the storage location stores erroneous data (e.g., the erroneous data 210) having one or more correctable errors. The storage, storage location, and erroneous data may be any of the various types already mentioned.

At block 342, an ECC decoder (e.g., the ECC decoder 213) for and/or corresponding to the storage detects an ECC error, provides a signal or other indication of the ECC error, and outputs corrected data (e.g., the data 214) that has been corrected of the one or more correctable errors.

At block 343, information associated with the ECC error and/or the erroneous data may be stored in an error log. In some embodiments, exception handler circuitry or other circuitry of the processor may store this information in the error log. In some embodiments, the information may include information to indicate the storage location (e.g., the storage location 206) storing the erroneous data (e.g., information to indicate a specific general-purpose register, a specific vector register, a specific cache line, a specific memory address, etc.). In some embodiments, the information may optionally include information to indicate the storage (e.g., the storage 204) having the storage location (e.g., information to indicate the error was in a set of general-purpose registers, a set of floating-point registers, a set of vector registers, an L1 data cache, an L1 instruction cache, an L2 cache, an L3 cache, a system cache, a shared memory, a tightly coupled memory, external system memory, etc.), information to indicate a cause of the error (e.g., an ECC type of error), information to indicate a type of the error (e.g., a correctable ECC error (e.g., a single-bit ECC error), an uncorrectable ECC error (e.g., a double-bit ECC error), etc.), or any combination thereof. In some embodiments, storing this information in the error log may include storing this information in one or more registers of the processor (e.g., one or more control and/or status registers, model specific registers, etc.).

At block 344, the reported ECC error may trigger an exception (e.g., an ECC exception). The exception may also sometimes be referred to by other terms such as a trap, a fault, etc.

At block 345, the processor may transition to an exception handler corresponding to the exception (e.g., the ECC exception). Before changing the flow of execution, the processor may automatically save at least some of the current program's state. This often includes storing or preserving the current instruction pointer or current program counter, such as, for example by pushing it onto a stack. Other register values or state may also be similarly stored or preserved. This saved state may be used to resume execution of the program later. The processor may use the exception type (e.g., ECC error, which may be recorded in an error log) to identify the address of the appropriate exception handler. For example, an exception vector for the exception type may be used to look up the address in an interrupt descriptor table (IDT) or other exception vector table having entries that store the addresses of appropriate exception handlers for the different corresponding exception types. Sometimes (e.g., when the current program is in user mode) a mode transition may occur. For example, the processor may transition from a less privileged mode (e.g., user mode) used for the currently running program to a more privileged mode (e.g., kernel mode) able to run the exception handler. The address or instruction pointer of the appropriate exception handler may be stored in the instruction pointer register and the processor may jump, branch, or otherwise start executing at the memory address of the appropriate exception handler (e.g., the ECC exception handler) that was identified in the exception vector table. The exception handler may represent software and/or firmware that is able to handle the relevant exception.

At block 346, additional ECC exceptions may optionally be temporarily disabled to prevent one or more further ECC exceptions due to the same erroneous data. For example, the operation to read the erroneous data as part of correcting the erroneous data may generate another ECC error, which may optionally be avoided if such ECC exceptions are disabled.

At block 347, the exception handler may read the information associated with the ECC error and/or the erroneous data from the error log. In some embodiments, the exception handler may read the information indicating the storage location (e.g., the storage location 206) storing the erroneous data. This information may allow the exception handler to know from where to read corrected data and where to write back the corrected data to overwrite the erroneous data. In some embodiments, any of the other optional information in the error log mentioned above may optionally be read (e.g., information to indicate the storage having the storage location, information to indicate a cause of the error, information to indicate the type of the error, or any combination thereof. In some embodiments, the exception handler may read this information from one or more registers of the processor (e.g., one or more control and/or status registers, model specific registers, etc.), although this is not required. This information may allow the exception handler to diagnose the ECC error as part of fixing or correcting the one or more correctable errors.

At block 348, the exception handler may perform one or more instructions (e.g., macroinstructions or instructions of an instruction set of the processor to perform operations, including to: (1) read corrected data (e.g., the corrected data 214), which has been corrected of one or more correctable errors present in the erroneous data (e.g., the erroneous data 210) by the ECC decoder (e.g., the ECC decoder 213 using ECC bits (e.g., the ECC bits 208), from a storage location (e.g., the storage location 206); and (2) store the corrected data back to the storage location overwriting the erroneous data thereby effectively correcting or fixing the one or more correctable errors. Advantageously, this may help to prevent or at least reduce the accumulation of errors, which could otherwise result in too many errors for ECC to be able to correct or even detect them.

At block 349, optionally additional ECC exceptions may be re-enabled. This may mainly occur if the additional ECC exceptions were optionally disabled at block 346.

At block 350, the exception handler may return to the program that previously accessed erroneous data and took the exception. For example, the exception handler may execute a return from exception instruction (e.g., the interrupt return (IRET) instruction in x86).

At block 351, the processor may resume execution of the program. The processor may restore the saved or preserved state of the program (e.g., from the stack), including storing the instruction pointer of the instruction on which the exception occurred in the instruction pointer register.

An alternate possible approach, instead of allowing the exception handler to overwrite the erroneous data with the corrected data and thereby fix the one or more errors in the erroneous data, could be to use dedicated hardware to do this. Typically, different sets of such dedicated hardware may need to be provided for each of the different types of storage (e.g., a first set of such dedicated hardware for the general-purpose registers, a second set of such dedicated hardware for the L1 data cache, a third set of dedicated hardware for the L2 cache, and so on). The dedicated hardware may stall (e.g., halt) the processor, control access to the storage having the erroneous data, and write the corrected data over the erroneous data. Often there is a flush of the pipeline and then the execution of the instruction that had encountering the ECC error may be restarted.

However, allowing the exception handler to perform the one or more instructions to overwrite the erroneous data with the corrected data and thereby fixing the one or more errors in the erroneous data may tend to offer one or more advantages over the approach using such dedicated hardware. For one thing, the dedicated hardware approach generally tends to add a significant amount of additional hardware (e.g., circuitry or other logic), especially when the dedicated hardware is essentially replicated for different types of storage. This additional hardware may tend to increase die size and/or power consumption and/or manufacturing cost. Most if not all of this dedicated hardware is not needed for the exception handler approach, which largely leverages the processors existing exception delivery features and uses the exception handler which is implemented primarily in software and/or firmware. For another thing, the dedicated hardware approach is generally limited to memory within the processor or chip and/or is not able to correct errors in external system memory. Conversely, the exception handler approach may be used to correct errors in external system memory when such external memory provides ECC capabilities. For another thing, in some cases, the additional hardware may tend to further limit timing critical sections of the processor (e.g., tend to limit maximum frequencies). The exception handler approach does not have this drawback or at least not to the same extent. For yet another thing, the dedicated hardware approach may also be challenging to implement in a lockstep system where a first core or other processor mimics the operation and/or performs redundant processing for a second core or other processor. In such a lockstep system, when one core or processor experiences an error the correction of the error by the dedicated hardware may cause the core or processor experiencing the error to fall out of lockstep with the other core or processor. Commonly these lockstep systems are used in situations where maintaining lockstep is important. Conversely, the exception handler approach may be easier to implement in a lockstep system. In such a lockstep system, when one core or processor experiences an ECC error it may signal or alert the other core or processor of the ECC error, and then both cores or processors may enter the exception handler and perform the same operations so that the cores or processors are able to remain in lockstep.

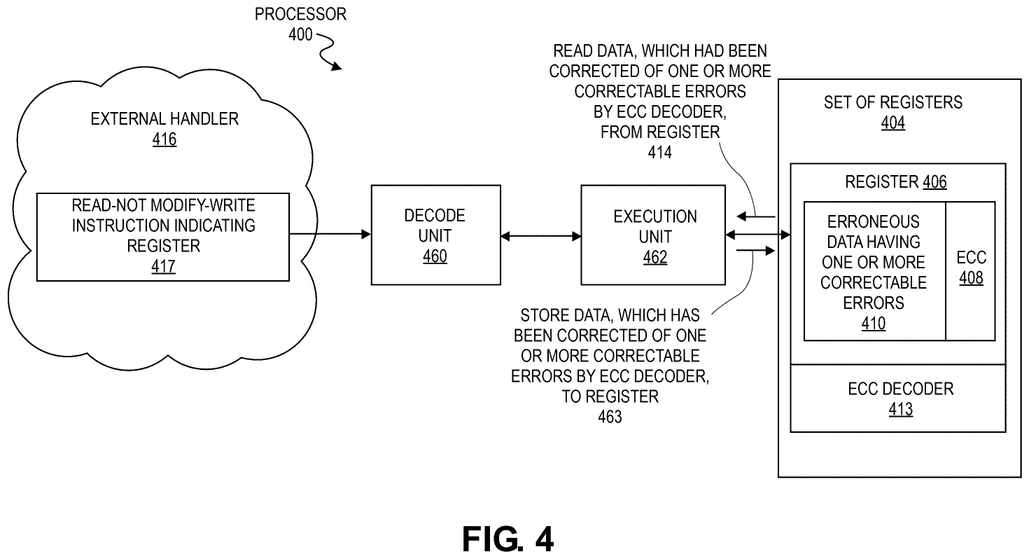

FIG. 4 is a block diagram of a first embodiment of an exception handler 416 having a read-not modify-write instruction 417 and a processor 400 to perform the read-not modify-write instruction 417. The processor may be one of the types previously described (e.g., a CPU, GPU, DSP, FPGA, ASIC, artificial intelligence processor, machine-learning processor, microcontroller, etc.). In some embodiments, the processor may include (e.g., be disposed on) at least one integrated circuit or semiconductor die. In some embodiments, the processor may include at least some hardware (e.g., transistors, integrated circuitry, random access memory (RAM), or the like).

The exception handler 416 includes the read-not modify-write instruction 417. The processor 400 may be coupled to receive the read-not modify-write instruction. For example, the processor may have a fetch unit or prefetch unit to fetch or prefetch the read-not modify-write instruction from system memory into an instruction cache. The read-not modify-write instruction may represent a macroinstruction or other instruction of an instruction set of the processor. In some embodiments, the read-not modify-write instruction may explicitly specify (e.g., through one or more fields or a set of bits), or otherwise indicate (e.g., implicitly indicate), a register 406 in a set of registers 404. The read-not modify-write instruction may indicate the register 406 as both a source for a read operation and as a destination for a write operation. The various types of read-not modify-write instructions mentioned above are suitable (e.g., a register-to-register move instruction specifying the same register as a source and a destination, a multiply instruction that multiplies a source register by one and stores the result to a destination register, etc.).

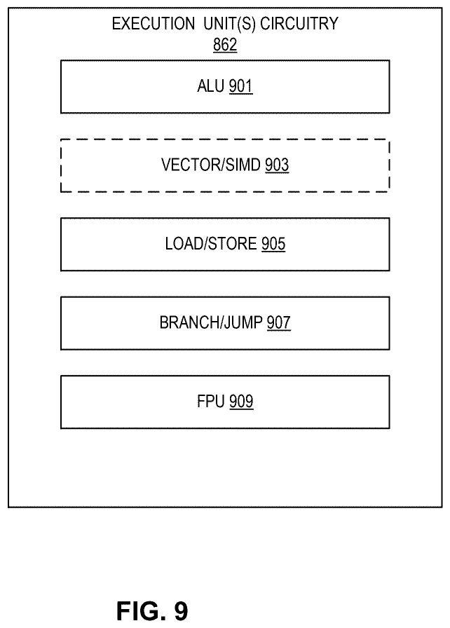

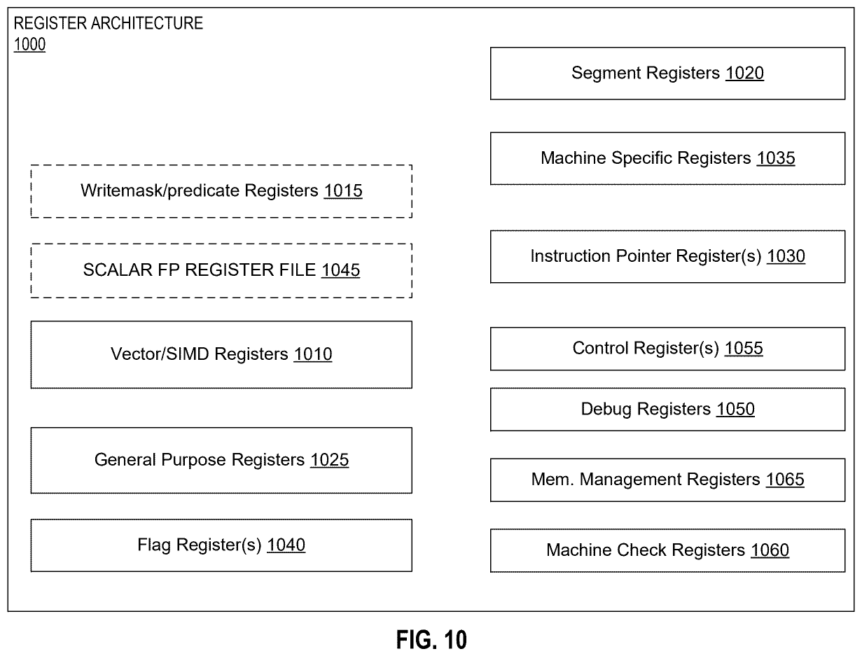

The set of registers 404 may be general-purpose registers, floating-point registers, vector registers, or other registers, as previously described. The registers may represent architecturally-visible or architectural registers that are visible to software and/or a programmer and/or are the registers indicated by instructions of the instruction set of the processor to identify operands. The registers may be implemented in different ways in different microarchitectures and are not limited to any particular type of design. Examples of suitable types of registers include, but are not limited to, dedicated physical registers, dynamically allocated physical registers using register renaming, and combinations thereof. Specific examples of the suitable registers include, but are not limited to, the registers shown in FIG. 10.

The processor includes a decode unit 460. The decode unit may receive and decode the read-not modify-write instruction. The decode unit may output one or more relatively lower-level instructions or control signals (e.g., one or more microinstructions, micro-operations, micro-code entry points, decoded instructions or control signals, etc.) that represent and/or are derived from the read-not modify-write instruction. The decode unit may be implemented using various instruction decode mechanisms including, but not limited to, microcode read only memories (ROMs), look-up tables, hardware implementations, programmable logic arrays (PLAs), other mechanisms suitable to implement decode units, and combinations thereof.

An execution unit 462 is coupled with the decode unit 460 and the registers 404. In various embodiments, depending upon the particular type of read-not modify-write instruction, the execution unit may be an arithmetic unit, an arithmetic logic unit (ALU), a vector unit, a multiplication unit, etc. In some embodiments, the execution unit may be on a die or integrated circuit with the decode unit. The execution unit may be coupled to receive the one or more relatively lower-level instructions or control signals. The execution unit may perform operations in response to and/or based on and/or corresponding to the read-not modify-write instruction. In some embodiments the operations may include to: (1) read corrected data 414, which has been corrected of one or more correctable errors present in erroneous data 410 by the ECC decoder 413 using ECC bits 408, from the register 406; and (2) store or write the corrected data 463, without modifying or changing the corrected data, back to the register 406 overwriting the erroneous data 410 thereby effectively correcting or fixing the one or more correctable errors in the erroneous data 410. Advantageously, this may help to prevent or at least reduce the accumulation of errors which could otherwise result in too many errors for the ECC bits and ECC decoder to be able to correct or even detect them.

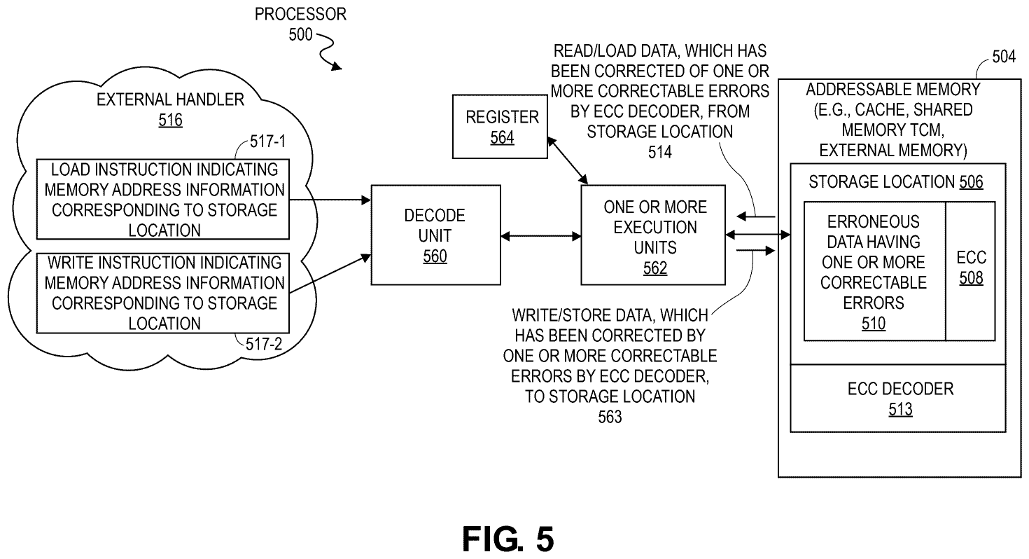

FIG. 5 is a block diagram of a second embodiment of an exception handler 516 having a load instruction 517-1 and a write instruction 517-2 and processor 500 to perform the load instruction and the write instruction. The processor may be one of the types previously described (e.g., a CPU, GPU, DSP, FPGA, ASIC, artificial intelligence processor, machine-learning processor, microcontroller, etc.). In some embodiments, the processor may include (e.g., be disposed on) at least one integrated circuit or semiconductor die. In some embodiments, the processor may include at least some hardware (e.g., transistors, integrated circuitry, random access memory (RAM), or the like).

The exception handler 516 includes the load instruction 517-1 and the write instruction 517-2. The processor may be coupled to receive the load and write instructions. For example, the processor may have a fetch unit or prefetch unit to fetch or prefetch the load and write instructions from system memory into an instruction cache. The load and write instructions may represent macroinstructions or other instruction of an instruction set of the processor. The load instruction may explicitly specify (e.g., through one or more fields or a set of bits), or otherwise indicate (e.g., implicitly indicate), memory address information corresponding to a storage location 506 in an addressable memory 504. The write instruction may explicitly specify (e.g., through one or more fields or a set of bits), or otherwise indicate (e.g., implicitly indicate), memory address information corresponding to the same storage location 506 in the addressable memory. Various different types of memory address information are suitable, such as, for example, providing a base and offset in registers and/or immediates, providing an offset from a segment, etc. Examples of suitable types of the addressable memory include, but are not limited to, an L1 instruction cache, an L1 data cache, a unified L2 cache, an L3 cache, a shared cache, a shared memory, a tightly coupled memory, and external system memory.

The processor includes a decode unit 560. The decode unit may receive and decode the load and write instructions. The decode unit may output one or more relatively lower-level instructions or control signals (e.g., one or more microinstructions, micro-operations, micro-code entry points, decoded instructions or control signals, etc.) that represent and/or are derived from each of the load and write instructions. The decode unit may be implemented using the various mechanisms already described (e.g., microcode ROM, PLAs, etc.).

One or more execution units 562 are coupled with the decode unit 560 and the addressable memory 504. In various embodiments, depending upon the particular type of read-not modify-write instruction, the execution unit may be a load unit and a store unit, a load-store unit, a memory execution unit, a memory execution cluster, etc. In some embodiments, one or more execution units may be on a die or integrated circuit with the decode unit. The one or more execution units may be coupled to receive the one or more relatively lower-level instructions or control signals for each of the load and write instructions. The one or more execution units may perform operations in response to and/or based on and/or corresponding to both the load and write instructions.

The one or more execution units may perform operations in response to and/or based on and/or corresponding to both the load and write instructions. In some embodiments the operations may include to: (1) execute or perform the load instruction to read or load corrected data 514, which has been corrected of one or more correctable errors present in erroneous data 510 by the ECC decoder 513 using ECC bits 508, from the storage location 506; and (2) execute or perform the write instruction to store or write the corrected data 563, without modifying or changing the corrected data, back to the storage location 506 overwriting the erroneous data 510 thereby effectively correcting or fixing the one or more correctable errors in the erroneous data. Advantageously, this may help to prevent or at least reduce the accumulation of errors which could otherwise result in too many errors for the ECC bits and ECC decoder to be able to correct or even detect them.

In some embodiments, the exception handler may need or expect to use integer registers and/or general-purpose registers for its execution. As a result, the state or contents of these integer registers or general-purpose registers may commonly be saved to the stack before switching to the exception handler and restored from the stack to these integer or general-purpose registers when returning from the exception handler. The correction of correctable ECC errors in these registers may therefore be done during the restore operation such that there may be no need to perform other instruction specifically to correct these ECC errors by overwriting the erroneous data. Depending upon the particular processor, this save and store may in some cases be done automatically by hardware of the processor or in other cases by software and/or firmware.

Instruction caches are often read only from the processor side and there is often no write path from the core or pipeline of the processor to the instruction cache. When one or more correctable ECC errors are detected, the corrected instruction may be provided to the execution pipeline of the processor. In some cases, no further action may need to be taken. When an uncorrectable error is detected on an instruction read from the instruction cache, in some embodiments it may optionally be treated as a cache miss and the cache line may be flushed the cache line and re-fetched from system memory. One or more ECC errors encountered during a cache line fill from external memory may be forwarded to the core and raise the associated ECC exception. In some embodiments, to correct one or more ECC errors in an instruction tightly coupled memory, the processor pipeline or core may be adapted to have both read and write access to the instruction tightly coupled memory (e.g., by coupling the data bus or another bus, interconnect, or connection, with the instruction tightly coupled memory.

As discussed above, information associated with one or more errors and/or an ECC exception may be stored in an error log to store information associated with an ECC error. The error log may be in registers of the processor (e.g., control and/or status registers, machine-specific registers, model specific registers, etc.) or elsewhere (e.g., in system memory). To further illustrate certain concepts, specific examples of registers used for an error log according to one detailed example embodiment will be provided. In other embodiments, any of the information mentioned for these registers may be stored in one or more other registers or another error log (e.g., in system memory).

In one detailed example embodiment, three control and/or status registers may optionally be used to implement an error log. These three registers are referred to as MCAUSE, MTVAL, and MTVAL2, although these names are arbitrary. In other embodiments, any of what is described for these registers may be stored in one or more registers or another error log. The MCAUSE register may be written with a code indicating the cause of an event, being an exception or interrupt. An ECC error may be considered a hardware error with a particular predetermined code (e.g., as one illustrative example 'h13 ('d19), although the scope of the invention is not so limited). For an ECC error during a load/store or instruction fetch error, the MTVAL register may contain the violating address. For ECC errors on internal resources (e.g. a register file, floating point registers) the MTVAL register may contain an indication of the offending register number (e.g., in one example embodiment encoded as one bit per register). For example, in such an example embodiment, if reading the register x2 causes a single bit ECC fault, then MTVAL is set to 'h4, although this is just one example. The MTVAL2 register may extend the information in the MTVAL register with exception specific information to assist the firmware in handling the trap or exception. The MTVAL2 register may contain a decimal number representing the location that triggered the hardware error exception (e.g., ECC exception). Table 1 below shows bits of an MTVAL2 register and how they are mapped to different corresponding ECC error sources, according to one detailed example embodiment.

TABLE 1
MTVAL2 bits and corresponding ECC error sources.

| Bit | ECC Error Source |
|---|---|
| 0 | GPR ECC Correctable Error |
| 1 | GPR ECC Uncorrectable Error |
| 2 | FPR ECC Correctable Error |
| 3 | FPR ECC Uncorrectable Error |
| 4 | VPR ECC Correctable Error |
| 5 | VPR ECC Uncorrectable Error |
| 6 | Reserved |
| 7 | CSR Uncorrectable Error |
| 8 | Instruction Cache TAG RAM Correctable Error |
| 9 | Instruction Cache TAG RAM Uncorrectable Error |
| 10 | Instruction Cache Data RAM Correctable Error |
| 11 | Instruction Cache Data RAM Uncorrectable Error |
| 12 | Instruction Load Correctable Error |
| 13 | Instruction Load Uncorrectable Error |
| 14 | Reserved |
| 15 | Reserved |
| 16 | Data Cache TAG RAM Correctable Error |
| 17 | Data Cache TAG RAM Uncorrectable Error |
| 18 | Data Cache Data RAM Correctable Error |
| 19 | Data Cache Data RAM Uncorrectable Error |
| 20 | Data Load Correctable Error |
| 21 | Data Load Uncorrectable Error |
| 22 | Data Store Correctable Error |
| 23 | Data Store Uncorrectable Error |
| 2\hat{ }MXLEN-1:24 | Reserved |

In some embodiments, one or more registers of the processor may be used to specify or indicate whether correction of one or more correctable ECC registers by an exception handler is enabled (e.g., turned on) or disabled (e.g., turned off) for two or more different types of storage. The two or more different types of storage may include general-purpose registers, an L1 instruction cache, an L1 data cache, an L2 cache, an L3 cache, a shared cache, a shared memory, a tightly coupled memory, external system memory, or any combination thereof. In some embodiments, the one or more registers may have two or more fields where each of the fields corresponds to a different one of the two or more different types of storage. Each of the fields may be used to store either a first value to enable (e.g., turn on) correction of the one or more correctable errors by an exception handler for the corresponding storage or a second value to disable (e.g., turn off) the correction of the one or more correctable errors by the exception handler for the corresponding storage. According to one possible convention, the first value is a value of a single bit being set to binary one or having a high value and the second value is a value of the single bit being cleared to binary zero or having a low value. This may allow a user or program to control which ECC errors on which storage are going to use the approach described herein.

In one detailed example embodiment, a single register, referred to as ALT_ECC_STATUS although this name is arbitrary, may optionally be used to store such enable/disable controls. In other embodiments, any of what is described for this register may optionally be used or stored in one or more other registers or control structures. The ALT_ECC_STATUS register may specify which ECC sources and error types trigger an ECC exception and are to be corrected by an exception handler. According to one possible convention, if a bit is set to binary one, then the associated source/type triggers an ECC exception to be corrected/handled by the exception handler. If the bit is cleared to binary zero, then the associated source/type does not trigger an ECC exception and is not corrected/handled by the exception handler. The bit assignments may optionally follow the same numbering as used for MTVAL2. The MSB (MXLEN-1) may optionally act as a global ECC exception enable. If the MSB bit is cleared, then no ECC exceptions are generated or handled by the exception handler, even if source/type bits are individually enabled. Table 2 below shows bits of an ALT_ECC_STATUS register and how they are mapped to different corresponding ECC error sources, according to one detailed example embodiment.

TABLE 2
ALT_ECC_STATUS bits and corresponding ECC error sources.

| Bit | ECC Error Source |
|---|---|
| 0 | GPR ECC Correctable Error |
| 1 | GPR ECC Uncorrectable Error |
| 2 | FPR ECC Correctable Error |
| 3 | FPR ECC Uncorrectable Error |
| 4 | VPR ECC Correctable Error |
| 5 | VPR ECC Uncorrectable Error |
| 6 | Reserved |
| 7 | CSR Uncorrectable Error |
| 8 | Instruction Cache TAG RAM Correctable Error |
| 9 | Instruction Cache TAG RAM Uncorrectable Error |
| 10 | Instruction Cache Data RAM Correctable Error |
| 11 | Instruction Cache Data RAM Uncorrectable Error |
| 12 | Instruction Load Correctable Error |
| 13 | Instruction Load Uncorrectable Error |
| 14 | Reserved |
| 15 | Reserved |
| 16 | Data Cache TAG RAM Correctable Error |
| 17 | Data Cache TAG RAM Uncorrectable Error |
| 18 | Data Cache Data RAM Correctable Error |
| 19 | Data Cache Data RAM Uncorrectable Error |
| 20 | Data Load Correctable Error |
| 21 | Data Load Uncorrectable Error |
| 22 | Data Store Correctable Error |
| 23 | Data Store Uncorrectable Error |
| 30:24 | Reserved |
| 31 | ECC Exception Enable |

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are suitable.

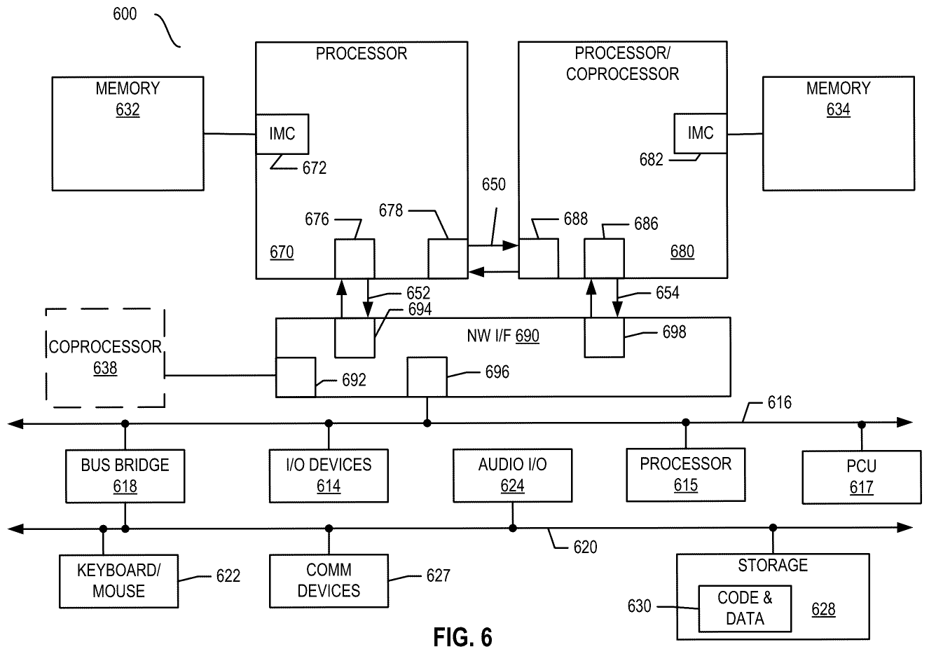

FIG. 6 illustrates an example computing system. Multiprocessor system 600 is an interfaced system and includes a plurality of processors or cores including a first processor 670 and a second processor 680 coupled via an interface 650 such as a point-to-point (P-P) interconnect, a fabric, and/or bus. In some examples, the first processor 670 and the second processor 680 are homogeneous. In some examples, the first processor 670 and the second processor 680 are heterogenous. Though the example system 600 is shown to have two processors, the system may have three or more processors or may be a single processor system. In some examples, the computing system is a system on a chip (SoC).

Processors 670 and 680 are shown including integrated memory controller (IMC) circuitry 672 and 682, respectively. Processor 670 also includes interface circuits 676 and 678; similarly, second processor 680 includes interface circuits 686 and 688. Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, the first interface 616 may be an interface such as a Peripheral Component Interconnect (PCI) interconnect, a PCI Express interconnect or another I/O interconnect. In some examples, the first interface 616 is coupled to a power control unit (PCU) 617, which may include circuitry, software, and/or firmware to perform power management operations regarding the processors 670, 680 and/or co-processor 638. PCU 617 provides control information to a voltage regulator (not shown) to cause the voltage regulator to generate the appropriate regulated voltage. PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, the second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage 'ISAB03 in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

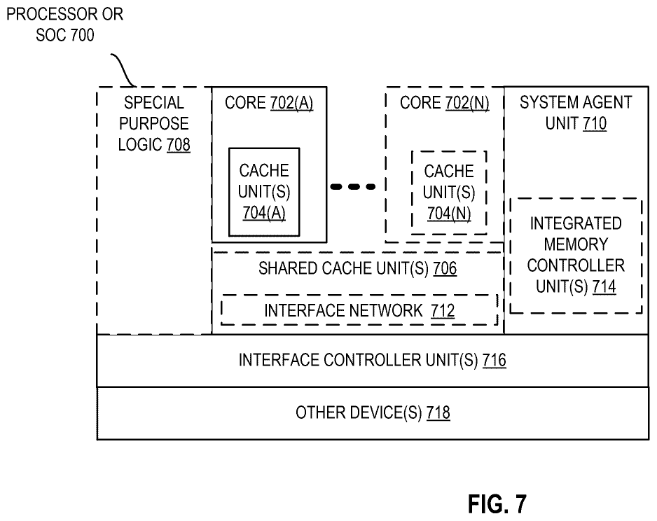

FIG. 7 illustrates a block diagram of an example processor and/or SoC 700 that may have one or more cores and an integrated memory controller. The solid lined boxes illustrate a processor 700 with a single core 702(A), system agent unit circuitry 710, and a set of one or more interface controller unit(s) circuitry 716, while the optional addition of the dashed lined boxes illustrates an alternative processor 700 with multiple cores 702(A)-(N), a set of one or more integrated memory controller unit(s) circuitry 714 in the system agent unit circuitry 710, and special purpose logic 708, as well as a set of one or more interface controller units circuitry 716. Note that the processor 700 may be one of the processors 670 or 680, or co-processor 638 or 615 of FIG. 6.

Thus, different implementations of the processor 700 may include: 1) a CPU with the special purpose logic 708 being integrated graphics and/or scientific (throughput) logic (which may include one or more cores, not shown), and the cores 702(A)-(N) being one or more general purpose cores (e.g., general purpose in-order cores, general purpose out-of-order cores, or a combination of the two); 2) a coprocessor with the cores 702(A)-(N) being a large number of special purpose cores intended primarily for graphics and/or scientific (throughput); and 3) a coprocessor with the cores 702(A)-(N) being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 700 may be a part of and/or may be implemented on one or more substrates using any of several process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller unit's circuitry 716 couple the cores 702 to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special purpose logic 708 (e.g., integrated graphics logic). The display unit circuitry is for driving one or more externally connected displays.

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

### Example Core Architectures-In-Order and Out-of-Order Core Block Diagram.

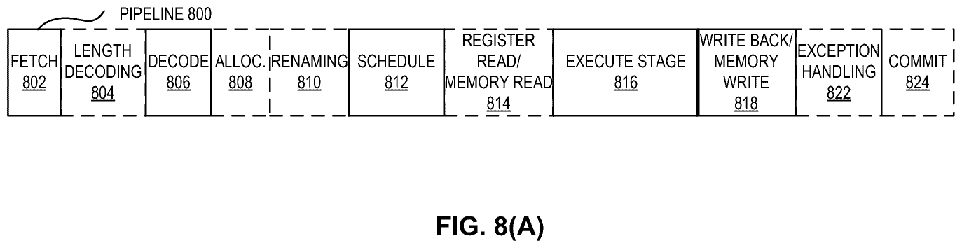

FIG. 8(A) is a block diagram illustrating both an example in-order pipeline and an example register renaming, out-of-order issue/execution pipeline according to examples. FIG. 8(B) is a block diagram illustrating both an example in-order architecture core and an example register renaming, out-of-order issue/execution architecture core to be included in a processor according to examples. The solid lined boxes in FIGS. 8(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 8(A), a processor pipeline 800 includes a fetch stage 802, an optional length decoding stage 804, a decode stage 806, an optional allocation (Alloc) stage 808, an optional renaming stage 810, a schedule (also known as a dispatch or issue) stage 812, an optional register read/memory read stage 814, an execute stage 816, a write back/memory write stage 818, an optional exception handling stage 822, and an optional commit stage 824. One or more operations can be performed in each of these processor pipeline stages. For example, during the fetch stage 802, one or more instructions are fetched from instruction memory, and during the decode stage 806, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 806 and the register read/memory read stage 814 may be combined into one pipeline stage. In one example, during the execute stage 816, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 8(B) may implement the pipeline 800 as follows: 1) the instruction fetch circuitry 838 performs the fetch and length decoding stages 802 and 804; 2) the decode circuitry 840 performs the decode stage 806; 3) the rename/allocator unit circuitry 852 performs the allocation stage 808 and renaming stage 810; 4) the scheduler(s) circuitry 856 performs the schedule stage 812; 5) the physical register file(s) circuitry 858 and the memory unit circuitry 870 perform the register read/memory read stage 814; the execution cluster(s) 860 perform the execute stage 816; 6) the memory unit circuitry 870 and the physical register file(s) circuitry 858 perform the write back/memory write stage 818; 7) various circuitry may be involved in the exception handling stage 822; and 8) the retirement unit circuitry 854 and the physical register file(s) circuitry 858 perform the commit stage 824.

FIG. 8(B) shows a processor core 890 including front-end unit circuitry 830 coupled to execution engine unit circuitry 850, and both are coupled to memory unit circuitry 870. The core 890 may be a reduced instruction set architecture computing (RISC) core, a complex instruction set architecture computing (CISC) core, a very long instruction word (VLIW) core, or a hybrid or alternative core type. As yet another option, the core 890 may be a special-purpose core, such as, for example, a network or communication core, compression engine, coprocessor core, general purpose computing graphics processing unit (GPGPU) core, graphics core, or the like.

The front-end unit circuitry 830 may include branch prediction circuitry 832 coupled to instruction cache circuitry 834, which is coupled to an instruction translation lookaside buffer (TLB) 836, which is coupled to instruction fetch circuitry 838, which is coupled to decode circuitry 840. In one example, the instruction cache circuitry 834 is included in the memory unit circuitry 870 rather than the front-end circuitry 830. The decode circuitry 840 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 840 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 840 may be implemented using various mechanisms. Examples of suitable mechanisms include, but are not limited to, look-up tables, hardware implementations, programmable logic arrays (PLAs), microcode read only memories (ROMs), etc. In one example, the core 890 includes a microcode ROM (not shown) or other medium that stores microcode for certain macroinstructions (e.g., in decode circuitry 840 or otherwise within the front-end circuitry 830). In one example, the decode circuitry 840 includes a micro-operation (micro-op) or operation cache (not shown) to hold/cache decoded operations, micro-tags, or micro-operations generated during the decode or other stages of the processor pipeline 800. The decode circuitry 840 may be coupled to rename/allocator unit circuitry 852 in the execution engine circuitry 850.

The execution engine circuitry 850 includes the rename/allocator unit circuitry 852 coupled to retirement unit circuitry 854 and a set of one or more scheduler(s) circuitry 856. The scheduler(s) circuitry 856 represents any number of different schedulers, including reservations stations, central instruction window, etc. In some examples, the scheduler(s) circuitry 856 can include arithmetic logic unit (ALU) scheduler/scheduling circuitry, ALU queues, address generation unit (AGU) scheduler/scheduling circuitry, AGU queues, etc. The scheduler(s) circuitry 856 is coupled to the physical register file(s) circuitry 858. Each of the physical register file(s) circuitry 858 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 858 includes vector registers unit circuitry, writemask registers unit circuitry, and scalar register unit circuitry. These register units may provide architectural vector registers, vector mask registers, general-purpose registers, etc. The physical register file(s) circuitry 858 is coupled to the retirement unit circuitry 854 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 854 and the physical register file(s) circuitry 858 are coupled to the execution cluster(s) 860. The execution cluster(s) 860 includes a set of one or more execution unit(s) circuitry 862 and a set of one or more memory access circuitry 864. The execution unit(s) circuitry 862 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include several execution units or execution unit circuitry dedicated to specific functions or sets of functions, other examples may include only one execution unit circuitry or multiple execution units/execution unit circuitry that all perform all functions. The scheduler(s) circuitry 856, physical register file(s) circuitry 858, and execution cluster(s) 860 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 864). It should also be understood that where separate pipelines are used, one or more of these pipelines may be out-of-order issue/execution and the rest in-order.

In some examples, the execution engine unit circuitry 850 may perform load store unit (LSU) address/data pipelining to an Advanced Microcontroller Bus (AMB) interface (not shown), and address phase and writeback, data phase load, store, and branches.

The set of memory access circuitry 864 is coupled to the memory unit circuitry 870, which includes data TLB circuitry 872 coupled to data cache circuitry 874 coupled to level 2 (L2) cache circuitry 876. In one example, the memory access circuitry 864 may include load unit circuitry, store address unit circuitry, and store data unit circuitry, each of which is coupled to the data TLB circuitry 872 in the memory unit circuitry 870. The instruction cache circuitry 834 is further coupled to the level 2 (L2) cache circuitry 876 in the memory unit circuitry 870. In one example, the instruction cache 834 and the data cache 874 are combined into a single instruction and data cache (not shown) in L2 cache circuitry 876, level 3 (L3) cache circuitry (not shown), and/or main memory. The L2 cache circuitry 876 is coupled to one or more other levels of cache and eventually to a main memory.

The core 890 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 890 includes logic to support a packed data instruction set architecture extension (e.g., AVX1, AVX2), thereby allowing the operations used by many multimedia applications to be performed using packed data.

### Example Execution Unit(s) Circuitry.

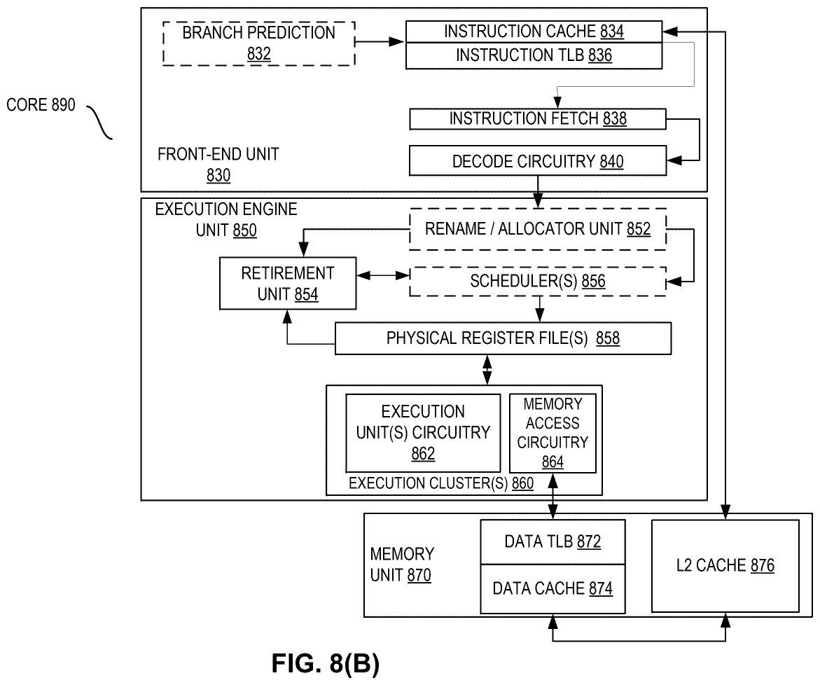

FIG. 9 illustrates examples of execution unit(s) circuitry, such as execution unit(s) circuitry 862 of FIG. 8(B). As illustrated, execution unit(s) circuitry 862 may include one or more ALU circuits 901, optional vector/single instruction multiple data (SIMD) circuits 903, load/store circuits 905, branch/jump circuits 907, and/or Floating-point unit (FPU) circuits 909. ALU circuits 901 perform integer arithmetic and/or Boolean operations. Vector/SIMD circuits 903 perform vector/SIMD operations on packed data (such as SIMD/vector registers). Load/store circuits 905 execute load and store instructions to load data from memory into registers or store from registers to memory. Load/store circuits 905 may also generate addresses. Branch/jump circuits 907 cause a branch or jump to a memory address depending on the instruction. FPU circuits 909 perform floating-point arithmetic. The width of the execution unit(s) circuitry 862 varies depending upon the example and can range from 16-bit to 1,024-bit, for example. In some examples, two or more smaller execution units are logically combined to form a larger execution unit (e.g., two 128-bit execution units are logically combined to form a 256-bit execution unit). Example Register Architecture.

FIG. 910 is a block diagram of a register architecture 91000 according to some examples. As illustrated, the register architecture 91000 includes vector/SIMD registers 91010 that vary from 128-bit to 1,024 bits width. In some examples, the vector/SIMD registers 91010 are physically 512-bits and, depending upon the mapping, only some of the lower bits are used. For example, in some examples, the vector/SIMD registers 91010 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 91000 includes writemask/predicate registers 91015. For example, in some examples, there are 8 writemask/predicate registers (sometimes called k0 through k7) that are each 16-bit, 32-bit, 64-bit, or 128-bit in size. Writemask/predicate registers 91015 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 91015 corresponds to a data element position of the destination. In other examples, the writemask/predicate registers 91015 are scalable and consists of a set number of enable bits for a given vector element (e.g., 8 enable bits per 64-bit vector element).

The register architecture 91000 includes a plurality of general-purpose registers 91025. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 91000 includes scalar floating-point (FP) register file 91045 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 91040 (e.g., EFLAGS, RFLAGS, etc.) store status and control information for arithmetic, compare, and system operations. For example, the one or more flag registers 91040 may store condition code information such as carry, parity, auxiliary carry, zero, sign, and overflow. In some examples, the one or more flag registers 91040 are called program status and control registers.

Segment registers 91020 contain segment points for use in accessing memory. In some examples, these registers are referenced by the names CS, DS, SS, ES, FS, and GS.

Machine specific registers (MSRs) 91035 control and report on processor performance. Most MSRs 91035 handle system-related functions and are not accessible to an application program. Machine check registers 91060 consist of control, status, and error reporting MSRs that are used to detect and report on hardware errors.

One or more instruction pointer register(s) 91030 store an instruction pointer value. Control register(s) 91055 (e.g., CR0-CR4) determine the operating mode of a processor (e.g., processor 670, 680, 638, 615, and/or 700) and the characteristics of a currently executing task. Debug registers 91050 control and allow for the monitoring of a processor or core's debugging operations.

Memory (mem) management registers 91065 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 91000 may, for example, be used in register file/memory 'ISAB08, or physical register file(s) circuitry 8 58.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

FIG. 1111 illustrates examples of an instruction format. As illustrated, an instruction may include multiple components including, but not limited to, one or more fields for: one or more prefixes 111101, an opcode 111103, addressing information 111105 (e.g., register identifiers, memory addressing information, etc.), a displacement value 111107, and/or an immediate value 111109. Note that some instructions utilize some or all the fields of the format whereas others may only use the field for the opcode 111103. In some examples, the order illustrated is the order in which these fields are to be encoded, however, it should be appreciated that in other examples these fields may be encoded in a different order, combined, etc.

The prefix(es) field(s) 111101, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 111103 is used to at least partially define the operation to be performed upon a decoding of the instruction. In some examples, a primary opcode encoded in the opcode field 111103 is one, two, or three bytes in length. In other examples, a primary opcode can be a different length. An additional 3-bit opcode field is sometimes encoded in another field.

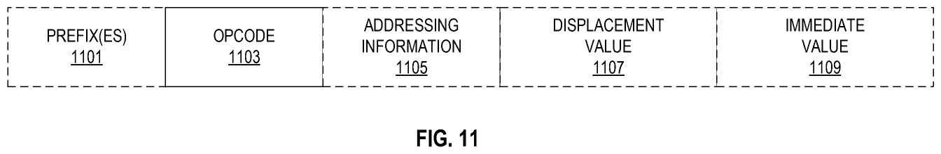

The addressing information field 111105 is used to address one or more operands of the instruction, such as a location in memory or one or more registers. FIG. 12 illustrates examples of the addressing information field 111105. In this illustration, an optional MOD R/M byte 1202 and an optional Scale, Index, Base (SIB) byte 1204 are shown. The MOD R/M byte 1202 and the SIB byte 1204 are used to encode up to two operands of an instruction, each of which is a direct register or effective memory address. Note that both fields are optional in that not all instructions include one or more of these fields. The MOD R/M byte 1202 includes a MOD field 1242, a register (reg) field 1244, and R/M field 1246.

The content of the MOD field 1242 distinguishes between memory access and non-memory access modes. In some examples, when the MOD field 1242 has a binary value of 11 (11b), a register-direct addressing mode is utilized, and otherwise a register-indirect addressing mode is used.

The register field 1244 may encode either the destination register operand or a source register operand or may encode an opcode extension and not be used to encode any instruction operand. The content of register field 1244, directly or through address generation, specifies the locations of a source or destination operand (either in a register or in memory). In some examples, the register field 1244 is supplemented with an additional bit from a prefix (e.g., prefix 111101) to allow for greater addressing.

The R/M field 1246 may be used to encode an instruction operand that references a memory address or may be used to encode either the destination register operand or a source register operand. Note the R/M field 1246 may be combined with the MOD field 1242 to dictate an addressing mode in some examples.

The SIB byte 1204 includes a scale field 1252, an index field 1254, and a base field 1256 to be used in the generation of an address. The scale field 1252 indicates a scaling factor. The index field 1254 specifies an index register to use. In some examples, the index field 1254 is supplemented with an additional bit from a prefix (e.g., prefix 111101) to allow for greater addressing. The base field 1256 specifies a base register to use. In some examples, the base field 1256 is supplemented with an additional bit from a prefix (e.g., prefix 111101) to allow for greater addressing. In practice, the content of the scale field 1252 allows for the scaling of the content of the index field 1254 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 111107 provides this value. Additionally, in some examples, a displacement factor usage is encoded in the MOD field of the addressing information field 111105 that indicates a compressed displacement scheme for which a displacement value is calculated and stored in the displacement field 111107.

In some examples, the immediate value field 111109 specifies an immediate value for the instruction. An immediate value may be encoded as a 1-byte value, a 2-byte value, a 4-byte value, etc.

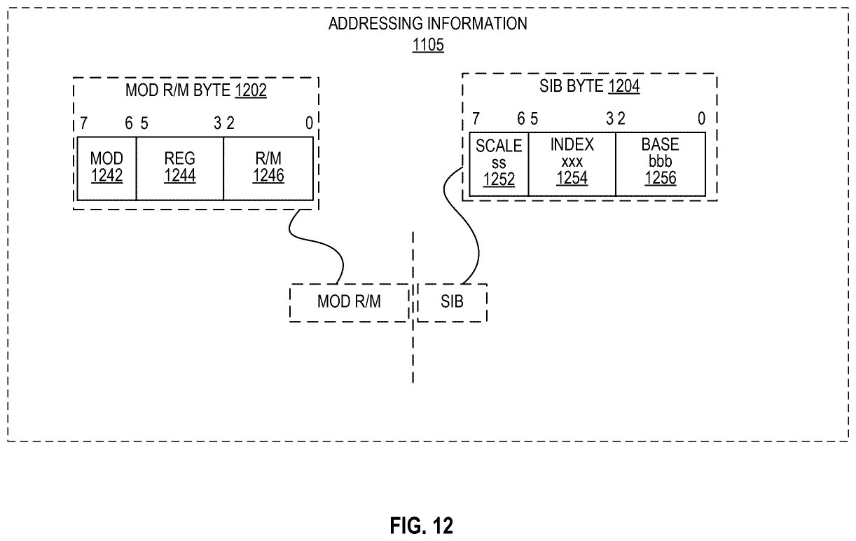

FIG. 13 illustrates examples of a first prefix 111101(A). In some examples, the first prefix 111101(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 111101(A) may specify up to three registers using 3-bit fields depending on the format: 1) using the reg field 1244 and the R/M field 1246 of the MOD R/M byte 1202; 2) using the MOD R/M byte 1202 with the SIB byte 1204 including using the reg field 1244 and the base field 1256 and index field 1254; or 3) using the register field of an opcode.

In the first prefix 111101(A), bit positions 7:4 are set as 0100. Bit position 3 (W) can be used to determine the operand size but may not solely determine operand width. As such, when W=0, the operand size is determined by a code segment descriptor (CS·D) and when W=1, the operand size is 64-bit.

Note that the addition of another bit allows for 16 (2⁴) registers to be addressed, whereas the MOD R/M reg field 1244 and MOD R/M R/M field 1246 alone can each only address 8 registers.

In the first prefix 111101(A), bit position 2 (R) may be an extension of the MOD R/M reg field 1244 and may be used to modify the MOD R/M reg field 1244 when that field encodes a general-purpose register, a 64-bit packed data register (e.g., a SSE register), or a control or debug register. R is ignored when MOD R/M byte 1202 specifies other registers or defines an extended opcode.

Bit position 1(X) may modify the SIB byte index field 1254.

Bit position 0(B) may modify the base in the MOD R/M R/M field 1246 or the SIB byte base field 1256; or it may modify the opcode register field used for accessing general purpose registers (e.g., general purpose registers 91025).

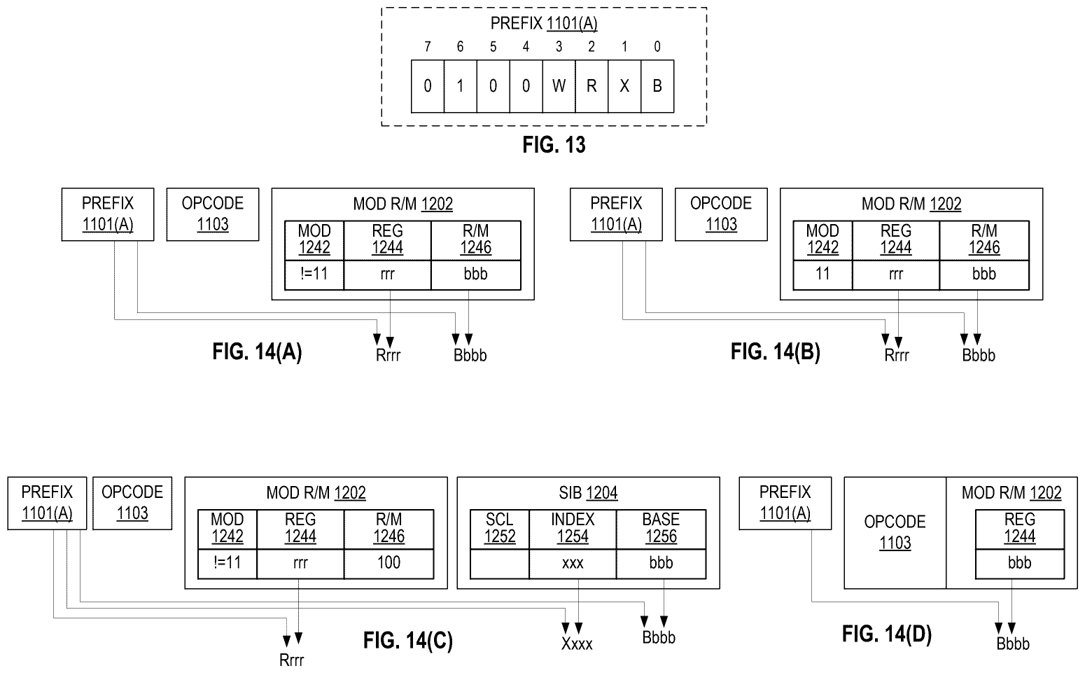

FIGS. 14(A)-(D) illustrate examples of how the R, X, and B fields of the first prefix 111101(A) are used. FIG. 14(A) illustrates R and B from the first prefix 111101(A) being used to extend the reg field 1244 and R/M field 1246 of the MOD R/M byte 1202 when the SIB byte 12 04 is not used for memory addressing. FIG. 14(B) illustrates R and B from the first prefix 111101(A) being used to extend the reg field 1244 and R/M field 1246 of the MOD R/M byte 1202 when the SIB byte 12 04 is not used (register-register addressing). FIG. 14(C) illustrates R, X, and B from the first prefix 111101(A) being used to extend the reg field 1244 of the MOD R/M byte 1202 and the index field 1254 and base field 1256 when the SIB byte 12 04 being used for memory addressing. FIG. 14(D) illustrates B from the first prefix 111101(A) being used to extend the reg field 1244 of the MOD R/M byte 1202 when a register is encoded in the opcode 111103.

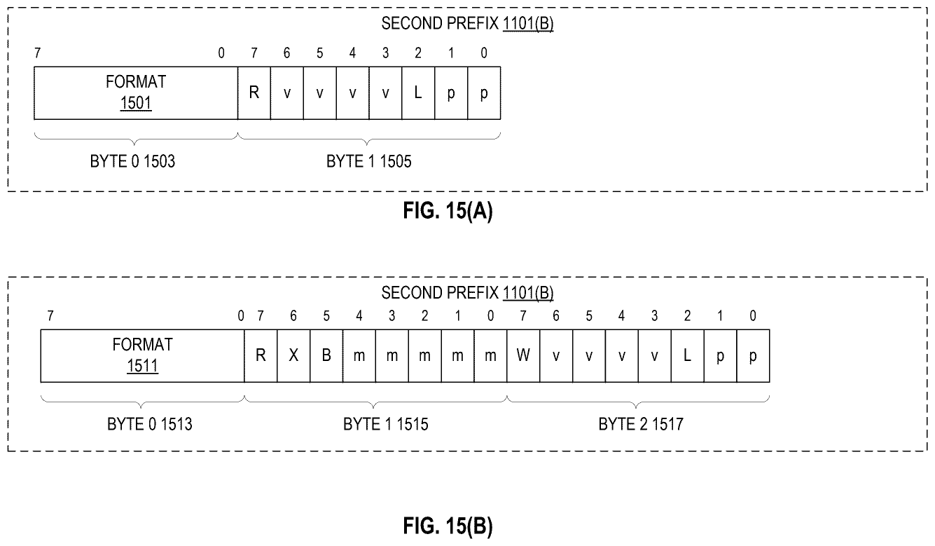

FIGS. 15(A)-(B) illustrate examples of a second prefix 111101(B). In some examples, the second prefix 111101(B) is an example of a VEX prefix. The second prefix 111101(B) encoding allows instructions to have more than two operands, and allows SIMD vector registers (e.g., vector/SIMD registers 91010) to be longer than 64-bits (e.g., 128-bit and 256-bit). The use of the second prefix 111101(B) provides for three-operand (or more) syntax. For example, previous two-operand instructions performed operations such as A=A+B, which overwrites a source operand. The use of the second prefix 111101(B) enables operands to perform nondestructive operations such as A=B+C.

In some examples, the second prefix 111101(B) comes in two forms—a two-byte form and a three-byte form. The two-byte second prefix 111101(B) is used mainly for 128-bit, scalar, and some 256-bit instructions; while the three-byte second prefix 111101(B) provides a compact replacement of the first prefix 111101(A) and 3-byte opcode instructions.

FIG. 15(A) illustrates examples of a two-byte form of the second prefix 111101(B). In one example, a format field 1501 (byte 0 1503) contains the value C5H. In one example, byte 1 1505 includes an “R” value in bit [7]. This value is the complement of the “R” value of the first prefix 111101(A). Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246 and the MOD R/M reg field 1244 encode three of the four operands. Bits [7:4] of the immediate value field 111109 are then used to encode the third source register operand.

FIG. 15(B) illustrates examples of a three-byte form of the second prefix 111101(B). In one example, a format field 1511 (byte 0 1513) contains the value C4H. Byte 1 1515 includes in bits [7:5] “R,” “X,” and “B” which are the complements of the same values of the first prefix 111101(A). Bits [4:0] of byte 1 1515 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit [7] of byte 2 1517 is used like W of the first prefix 111101(A) including helping to determine promotable operand sizes. Bit [2] is used to dictate the length (L) of the vector (where a value of 0 is a scalar or 128-bit vector and a value of 1 is a 256-bit vector). Bits [1:0] provide opcode extensionality equivalent to some legacy prefixes (e.g., 00=no prefix, 01=66H, 10=F3H, and 11=F2H). Bits [6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1246 to encode the instruction operand that references a memory address or encode either the destination register operand or a source register operand.

Instructions that use this prefix may use the MOD R/M reg field 1244 to encode either the destination register operand or a source register operand, or to be treated as an opcode extension and not used to encode any instruction operand.

For instruction syntax that supports four operands, vvvv, the MOD R/M R/M field 1246, and the MOD R/M reg field 1244 encode three of the four operands. Bits [7:4] of the immediate value field 111109 are then used to encode the third source register operand.

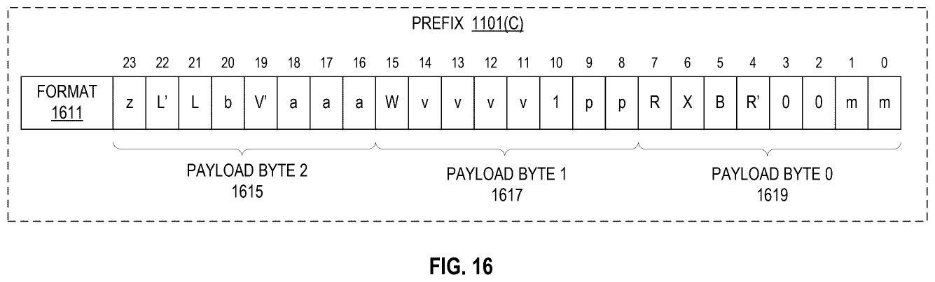

FIG. 16 illustrates examples of a third prefix 111101(C). In some examples, the third prefix 111101(C) is an example of an EVEX prefix. The third prefix 111101(C) is a four-byte prefix.

The third prefix 111101(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 910) or predication utilize this prefix. Opmask register allows for conditional processing or selection control. Opmask instructions, whose source/destination operands are opmask registers and treat the content of an opmask register as a single value, are encoded using the second prefix 111101(B).

The third prefix 111101(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 111101(C) is a format field 1611 that has a value, in one example, of 62H. Subsequent bytes are referred to as payload bytes 1615-1619 and collectively form a 24-bit value of P[23:0] providing specific capability in the form of one or more fields (detailed herein).

In some examples, P[1:0] of payload byte 1619 are identical to the low two mm bits. P[3:2] are reserved in some examples. Bit P[4] (R′) allows access to the high 16 vector register set when combined with P[7] and the MOD R/M reg field 1244. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1244 and MOD R/M R/M field 1246. P[9:8] provides opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is like W of the first prefix 111101(A) and second prefix 111111(B) and may serve as an opcode extension bit or operand size promotion.

P[18:16] specify the index of a register in the opmask (writemask) registers (e.g., writemask/predicate registers 91015). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 111101(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

Emulation (including binary translation, code morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

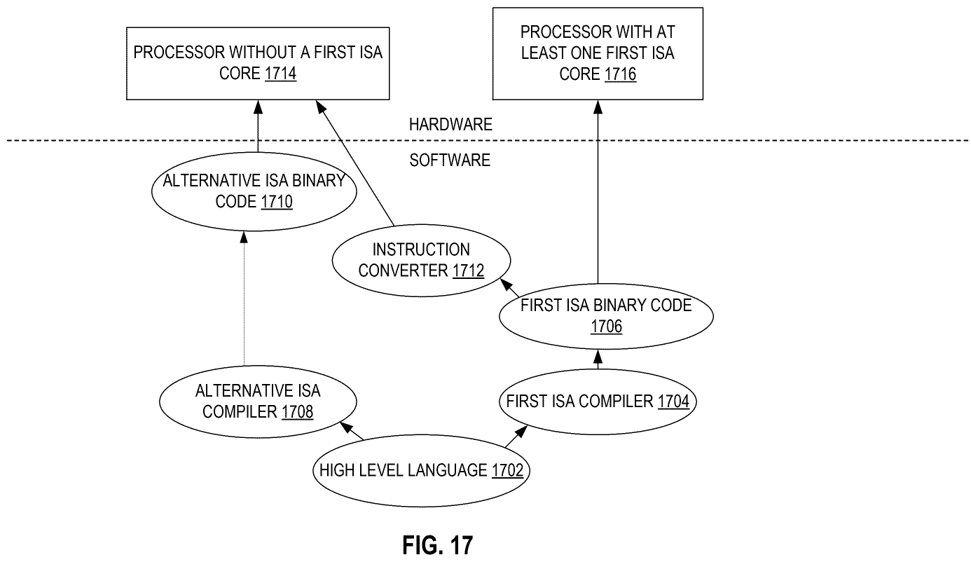

FIG. 17 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 17 shows a program in a high-level language 1702 may be compiled using a first ISA compiler 1704 to generate first ISA binary code 1706 that may be natively executed by a processor with at least one first ISA core 1716. The processor with at least one first ISA core 1716 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 1704 represents a compiler that is operable to generate the first ISA binary code 1706 (e.g., object code) that can, with or without additional linkage processing, be executed on the processor with at least one first ISA core 1716. Similarly, FIG. 17 shows the program in the high-level language 1702 may be compiled using an alternative ISA compiler 1708 to generate alternative ISA binary code 1710 that may be natively executed by a processor without a first ISA core 1714. The instruction converter 1712 is used to convert the first ISA binary code 1706 into code that may be natively executed by the processor without a first ISA core 1714. This converted code is not necessarily to be the same as the alternative ISA binary code 1710; however, the converted code will accomplish the general operation and be made up of instructions from the alternative ISA. Thus, the instruction converter 1712 represents software, firmware, hardware, or a combination thereof that, through emulation, simulation, or any other process, allows a processor or other electronic device that does not have a first ISA processor or core to execute the first ISA binary code 1706.

Components, features, and details described for any of the processors disclosed herein (e.g., 100, 200, 400, 500) may optionally apply to any of the methods disclosed herein (e.g., 340), which in embodiments may optionally be performed by and/or with such processors. Any of the processors described herein (e.g., 100, 200, 400, 500) in embodiments may optionally be included in any of the systems disclosed herein. Any of the processors disclosed herein (e.g., 100, 200, 400, 500) may optionally have any of the microarchitectures shown herein.

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, yet still co-operate or interact with each other. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals-such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### EXAMPLE EMBODIMENTS

The following examples pertain to further embodiments. Specifics in the examples may be used anywhere in one or more embodiments.

Example 1 is a processor or other apparatus that includes a storage having a plurality of storage locations, including a storage location to store data, an execution unit to execute an instruction to access the data, and an error correction code (ECC) decoder. The ECC decoder, when the data is erroneous data having one or more correctable errors, is to detect the one or more correctable errors in the erroneous data and correct the one or more correctable errors. The apparatus also includes circuitry to store information to indicate the storage location in an error log and circuitry to transition to an exception handler corresponding to an exception due to the one or more correctable errors.

Example 2 includes the apparatus of Example 1, where the storage is a set of registers. Optionally, where the storage location is a register of the set of registers, and where the information to indicate the storage location is a number of the register.

Example 3 includes the apparatus of any one of Examples 1 to 2, further including a decode unit to decode a second instruction of an exception handler. The second instruction to indicate a register of a set of registers as the storage location. Further including an execution unit to execute the second instruction to read the data, which has been corrected of the one or more correctable errors by the ECC decoder, from the register, and store the data, which has been corrected of the one or more correctable errors by the ECC decoder, to the register.

Example 4 includes the apparatus of Example 1, where the storage is selected from a group consisting of a cache, a shared memory, a tightly coupled memory, and external system memory. Optionally, where the information to indicate the storage location includes memory address information to indicate a memory address corresponding to the storage location.

Example 5 includes the apparatus of Example 4, where the storage is the external system memory.

Example 6 includes the apparatus of any one of Examples 1, 4 or 5, further including a decode unit to decode a second instruction and a third instruction. The second and third instructions being of an exception handler. The second and third instructions to each indicate memory address information corresponding to the storage location. The apparatus also includes one or more execution units to execute the second instruction to read the data, which has been corrected of the one or more correctable errors by the ECC decoder, from the storage location, and execute the third instruction to store the data, which has been corrected of the one or more correctable errors by the ECC decoder, to the storage location.

Example 7 includes the apparatus of any one of Examples 1 to 6, where the circuitry is further to store a plurality of following information in the error log: (1) information to indicate the storage; (2) information to indicate that the one or more correctable errors are correctable; and (3) information to indicate that the one or more correctable errors are one or more ECC errors.

Example 8 includes the apparatus of any one of Examples 1 to 7, further including one or more registers to store the error log.

Example 9 includes the apparatus of any one of Examples 1 to 8, further including one or more registers having a plurality of fields. Each of the plurality of fields corresponding to a different one of a plurality of different types of the storage. Each of the plurality of fields to store either a first value to enable correction of the one or more correctable errors by an exception handler or a second value to disable the correction of the one or more correctable errors by the exception handler.

Example 10 is a disk, memory, or other non-transitory machine-readable storage medium storing instructions that if executed by a machine are to cause the machine to perform operations. The operations include to read information indicative of a storage location of a storage from an error log, the storage location to store erroneous data having one or more correctable errors, read data, which has been corrected of the one or more correctable errors by an error correction code (ECC) decoder, from the storage location, store the data, which has been corrected of the one or more correctable errors, to the storage location, overwriting the erroneous data, and return to a program that previously accessed the erroneous data and took an exception.

Example 11 includes the non-transitory machine-readable storage medium of Example 10, where the storage is a set of registers. Optionally, where the storage location is a register of the set of registers, and where the information to indicate the storage location is a number of the register.

Example 12 includes the non-transitory machine-readable storage medium of any one of Examples 10 or 11, where the storage location is a register of a set of registers. Optionally, where the instructions include an instruction that is to indicate the register, and where the instruction if executed by the machine is to cause the machine to read the data, which has been corrected of the one or more correctable errors by the ECC decoder, from the register and store the data, which has been corrected of the one or more correctable errors by the ECC decoder, to the register.

Example 13 includes the non-transitory machine-readable storage medium of Example 10, where the storage is selected from a group consisting of a cache, a shared memory, a tightly coupled memory, and external system memory. Optionally, where the information to indicate the storage location includes memory address information to indicate a memory address corresponding to the storage location.

Example 14 includes the non-transitory machine-readable storage medium of any one of Examples 10 or 13, where the storage is selected from a group consisting of a cache, a shared memory, a tightly coupled memory, and external system memory. Optionally, where the instructions include a first instruction and a second instruction that are each to indicate memory address information corresponding to the storage location, where the first instruction if executed by the machine is to cause the machine to read the data, which has been corrected of the one or more correctable errors by the ECC decoder, from the storage location, and where the second instruction if executed by the machine is to cause the machine to store the data, which has been corrected of the one or more correctable errors by the ECC decoder, to the storage location.

Example 15 includes the non-transitory machine-readable storage medium of any one of Examples 10 to 14, where the storage is an external system memory.

Example 16 includes the non-transitory machine-readable storage medium of any one of Examples 10 to 15, where the instructions further comprise instructions that if executed by the machine are to cause the machine to read a plurality of following information from the error log: (1) information to indicate the storage; (2) information to indicate that the one or more correctable errors are correctable; and (3) information to indicate that the one or more correctable errors are one or more ECC errors.

Example 17 is a method including storing data in a storage location, accessing the data, detecting that the data has one or more correctable errors using error correction code (ECC) bits, correcting the one or more correctable errors using the ECC bits, storing information to indicate the storage location in an error log, and transitioning to an exception handler corresponding to an exception due to the one or more correctable errors.

Example 18 includes the method of Example 17, where the storage location is a register of a set of registers. Optionally, where the information to indicate the storage location is a number of the register.

Example 19 includes the method of Example 17, where the storage location is in a storage that is selected from a group consisting of a cache, a shared memory, a tightly coupled memory, and external system memory. Optionally, where the information to indicate the storage location includes memory address information to indicate a memory address corresponding to the storage location.

Example 20 includes the method of any one of Examples 17 to 19, further including decoding an instruction of an exception handler, the instruction indicating the storage location and executing the instruction, including reading the data, which has been corrected of the one or more correctable errors by using the ECC bits, from the storage location, and storing the data, which has been corrected of the one or more correctable errors by using the ECC bits, to the storage location.

Example 21 is a processor or other apparatus that includes means for performing the method of any one of Examples 17 to 20.

Example 22 is a processor or other apparatus that includes any combination of logic and/or circuitry and/or means operative to perform the method of any one of Examples 17 to 20.

Example 23 is a method comprising reading information indicative of a storage location of a storage from an error log, the storage location to store erroneous data having one or more correctable errors, reading data, which has been corrected of the one or more correctable errors by an error correction code (ECC) decoder, from the storage location, storing the data, which has been corrected of the one or more correctable errors, to the storage location, overwriting the erroneous data, and returning to a program that previously accessed the erroneous data and took an exception.

What is claimed is:

1. An apparatus comprising:
a storage having a plurality of storage locations, including a storage location to store data;
an execution unit to execute an instruction to access the data;
an error correction code (ECC) decoder, when the data is erroneous data having one or more correctable errors, to:
detect the one or more correctable errors in the erroneous data; and
correct the one or more correctable errors;
circuitry to store information to indicate the storage location in an error log; and
circuitry to transition to an exception handler corresponding to an exception due to the one or more correctable errors.

2. The apparatus of claim 1, wherein the storage is a set of registers, wherein the storage location is a register of the set of registers, and wherein the information to indicate the storage location is a number of the register.

3. The apparatus of claim 1, further comprising:
a decode unit to decode a second instruction of an exception handler, the second instruction to indicate a register of a set of registers as the storage location; and
an execution unit to execute the second instruction to:
read the data, which has been corrected of the one or more correctable errors by the ECC decoder, from the register; and
store the data, which has been corrected of the one or more correctable errors by the ECC decoder, to the register.

4. The apparatus of claim 1, wherein the storage is selected from a group consisting of a cache, a shared memory, a tightly coupled memory, and external system memory, and wherein the information to indicate the storage location includes memory address information to indicate a memory address corresponding to the storage location.

5. The apparatus of claim 4, wherein the storage is the external system memory.

6. The apparatus of claim 1, further comprising:
a decode unit to decode a second instruction and a third instruction, the second and third instructions being of an exception handler, the second and third instructions to each indicate memory address information corresponding to the storage location; and
one or more execution units to:
execute the second instruction to read the data, which has been corrected of the one or more correctable errors by the ECC decoder, from the storage location; and
execute the third instruction to store the data, which has been corrected of the one or more correctable errors by the ECC decoder, to the storage location.

7. The apparatus of claim 1, wherein the circuitry is further to store a plurality of following information in the error log:
information to indicate the storage;
information to indicate that the one or more correctable errors are correctable; and
information to indicate that the one or more correctable errors are one or more ECC errors.

8. The apparatus of claim 1, further comprising one or more registers to store the error log.

9. The apparatus of claim 1, further comprising one or more registers having a plurality of fields, each of the plurality of fields corresponding to a different one of a plurality of different types of the storage, each of the plurality of fields to store either a first value to enable correction of the one or more correctable errors by an exception handler or a second value to disable the correction of the one or more correctable errors by the exception handler.

10. A non-transitory machine-readable storage medium storing instructions that if executed by a machine are to cause the machine to perform operations, including to:
read information indicative of a storage location of a storage from an error log, the storage location to store erroneous data having one or more correctable errors;
read data, which has been corrected of the one or more correctable errors by an error correction code (ECC) decoder, from the storage location;
store the data, which has been corrected of the one or more correctable errors, to the storage location, overwriting the erroneous data; and
return to a program that previously accessed the erroneous data and took an exception.

11. The non-transitory machine-readable storage medium of claim 10, wherein the storage is a set of registers, wherein the storage location is a register of the set of registers, and wherein the information to indicate the storage location is a number of the register.

12. The non-transitory machine-readable storage medium of claim 10, wherein the storage location is a register of a set of registers, wherein the instructions include an instruction that is to indicate the register, and wherein the instruction if executed by the machine is to cause the machine to:
read the data, which has been corrected of the one or more correctable errors by the ECC decoder, from the register; and
store the data, which has been corrected of the one or more correctable errors by the ECC decoder, to the register.

13. The non-transitory machine-readable storage medium of claim 10, wherein the storage is selected from a group consisting of a cache, a shared memory, a tightly coupled memory, and external system memory, and wherein the information to indicate the storage location includes memory address information to indicate a memory address corresponding to the storage location.

14. The non-transitory machine-readable storage medium of claim 10, wherein the storage is selected from a group consisting of a cache, a shared memory, a tightly coupled memory, and external system memory, wherein the instructions include a first instruction and a second instruction that are each to indicate memory address information corresponding to the storage location, wherein the first instruction if executed by the machine is to cause the machine to read the data, which has been corrected of the one or more correctable errors by the ECC decoder, from the storage location, and wherein the second instruction if executed by the machine is to cause the machine to store the data, which has been corrected of the one or more correctable errors by the ECC decoder, to the storage location.

15. The non-transitory machine-readable storage medium of claim 10, wherein the storage is an external system memory.

16. The non-transitory machine-readable storage medium of claim 10, wherein the instructions further comprise instructions that if executed by the machine are to cause the machine to read a plurality of following information from the error log:
information to indicate the storage;
information to indicate that the one or more correctable errors are correctable; and
information to indicate that the one or more correctable errors are one or more ECC errors.

17. A method comprising:
storing data in a storage location;
accessing the data;
detecting that the data has one or more correctable errors using error correction code (ECC) bits;
correcting the one or more correctable errors using the ECC bits;
storing information to indicate the storage location in an error log; and
transitioning to an exception handler corresponding to an exception due to the one or more correctable errors.

18. The method of claim 17, wherein the storage location is a register of a set of registers, and wherein the information to indicate the storage location is a number of the register.

19. The method of claim 17, wherein the storage location is in a storage that is selected from a group consisting of a cache, a shared memory, a tightly coupled memory, and external system memory, and wherein the information to indicate the storage location includes memory address information to indicate a memory address corresponding to the storage location.

20. The method of claim 17, further comprising:
decoding an instruction of an exception handler, the instruction indicating the storage location; and
executing the instruction, including:
reading the data, which has been corrected of the one or more correctable errors by using the ECC bits, from the storage location; and
storing the data, which has been corrected of the one or more correctable errors by using the ECC bits, to the storage location.
